(19) United States
(12) Patent Application Publication
(10) Pub. No.: US 2026/0249409 A1
(43) Pub. Date: Aug. 27, 2026

(54) MODULAR LATHE TOOL ADAPTER

(71) Applicant: ENDURAPIN LLC, Sarasota, FL (US)

(72) Inventor: Nicholaus Bruce Hutchinson, Sarasota, FL (US)

(73) Assignee: ENDURAPIN LLC, Sarasota, FL (US)

(21) Appl. No.: 19/428,831

(22) Filed: Dec. 22, 2025

Related U.S. Application Data
(60) Provisional application No. 63/738,908, filed on Dec. 26, 2024.
(60) Provisional application No. 63/911,673, filed on Nov. 5, 2025.
(60) Provisional application No. 63/911,677, filed on Nov. 5, 2025.

(51) Int. Cl. B23Q 3/10; B23B 31/00

(52) U.S. Cl. CPC B23Q 3/105; B23B 31/005; B23B 2231/04

(57) ABSTRACT

Various embodiments relate generally to lathes or tool holders or both.

### RELATED APPLICATIONS

The present application claims priority to, and incorporates by reference the entirety of, each of: U.S. provisional patent application no. 63/738,908 filed Dec. 26, 2024, U.S. provisional patent application no. 63/911,673 filed Nov. 5, 2025, and U.S. provisional patent application no. 63/911,677 filed Nov. 5, 2025.

### TECHNICAL FIELD

Various embodiments relate generally to lathes or tool holders or both.

### BACKGROUND

In some industries, customization is a desirable feature for a product. For example, various companies utilize a make-to-order strategy that allows the consumer to customize a product before purchasing it.

### BRIEF DESCRIPTION OF THE DRAWINGS

FIG. 1 depicts a top perspective view of an illustrative modular lathe tool adapter.

FIG. 2 depicts a front perspective view of an exemplary modular lathe tool adapter, fastener, and tool holder.

FIG. 3 depicts a rear perspective view of an exemplary modular lathe tool adapter, fastener, and tool holder depicted in FIG. 2.

FIG. 4 depicts a bottom view of an illustrative modular lathe tool adapter.

FIG. 5 depicts a front perspective view of a modular lathe tool adapter coupled to a lathe turret.

FIG. 6 depicts an exemplary modular lathe tool adapter, tool holder, and cutting tool.

APPENDIX A depicts various views of a modular lathe tool adapter coupled to a lathe turret, the modular lathe tool adapter itself, and various connections the modular lathe tool adapter makes with different cutting tools.

APPENDIX B depicts various views of a modular lathe tool adapter coupled to a lathe turret, the modular lathe tool adapter itself, and various connections the modular lathe tool adapter makes with different cutting tools.

APPENDIX C depicts various views of coolant nozzles.

APPENDIX D depicts various views of coolant valves.

APPENDIX E depicts various views of lathe adapters and milling tool holders.

Like reference symbols in the various drawings indicate like elements.

### DETAILED DESCRIPTION OF ILLUSTRATIVE EMBODIMENTS

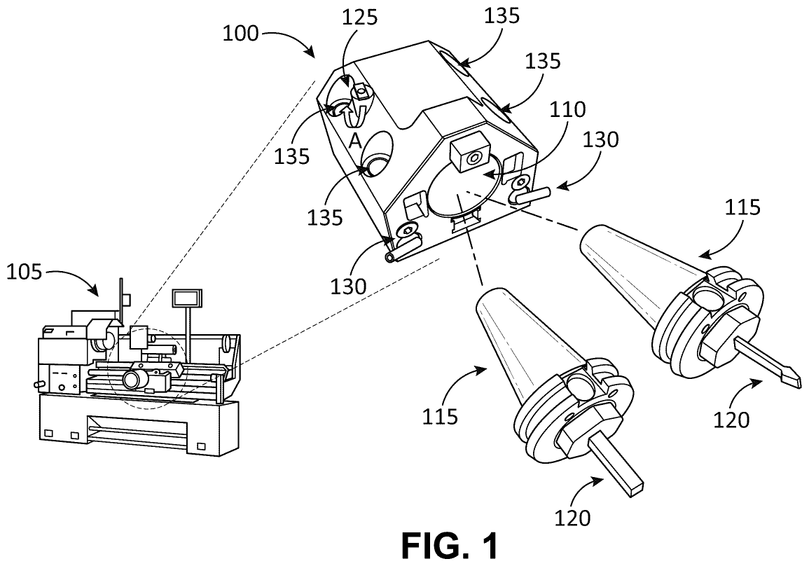

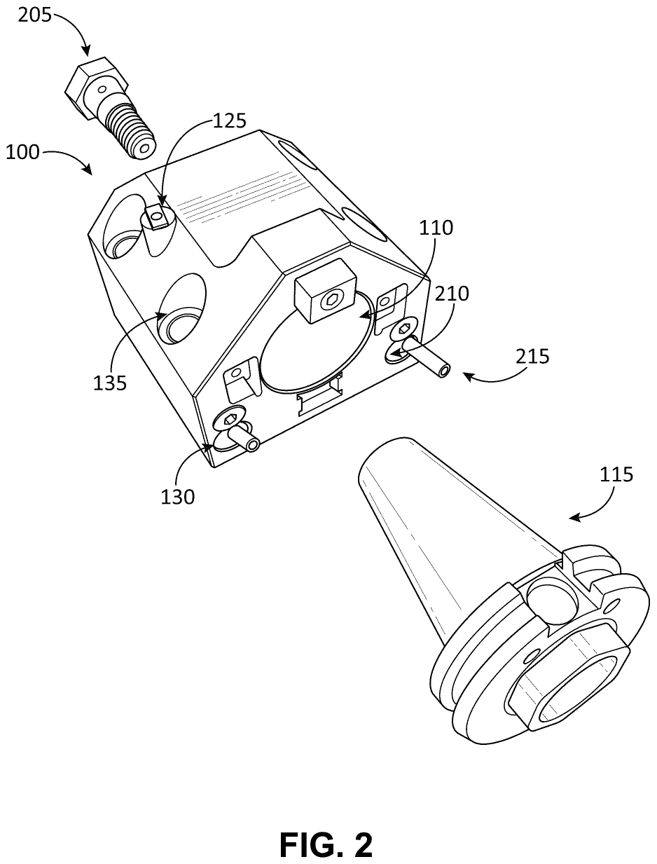

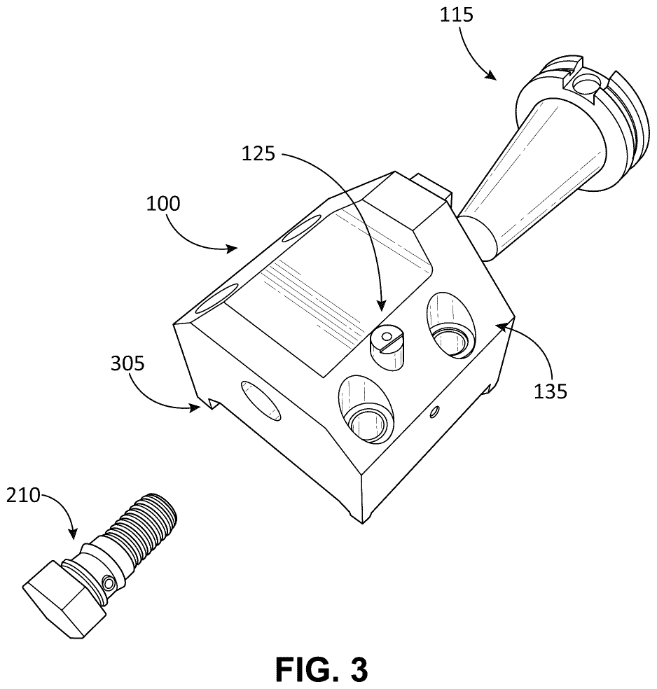

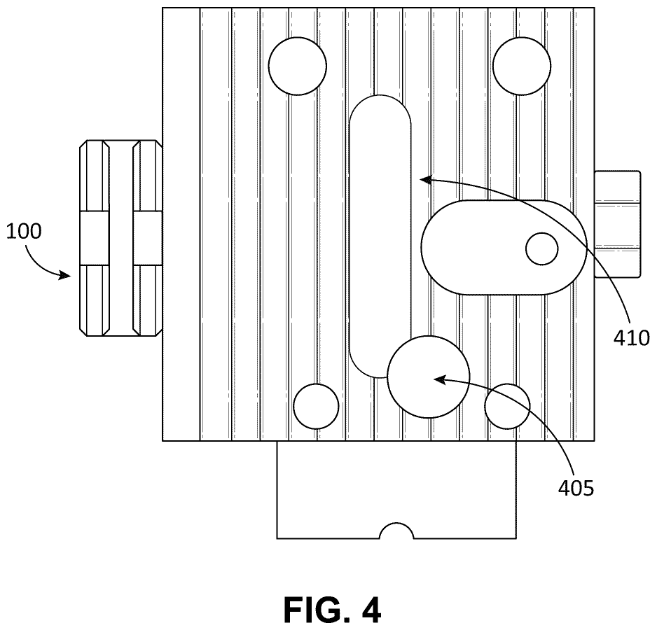

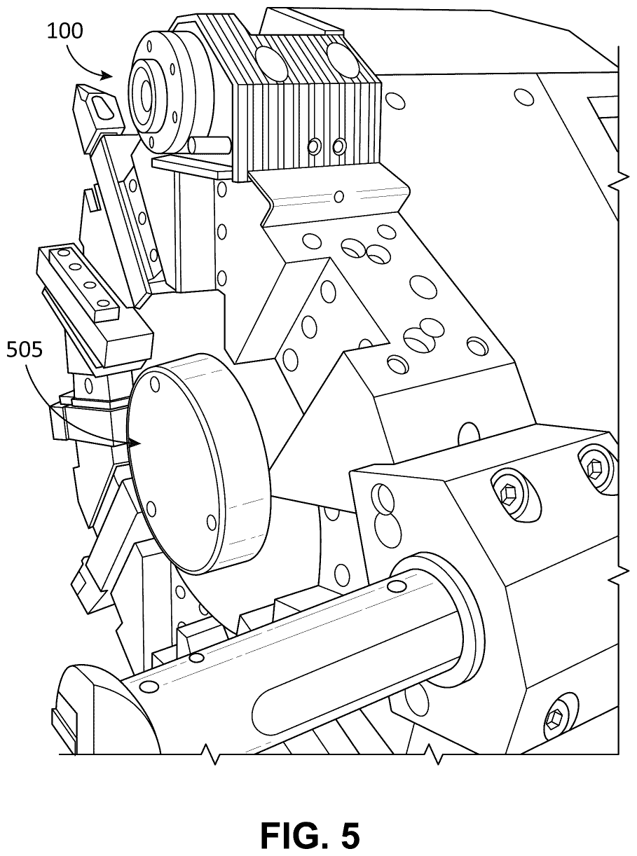

To aid understanding, this document is organized as follows. First, to help introduce discussion of various embodiments, a modular lathe tool adapter is introduced with reference to FIG. 1. Second, that introduction leads into a description with reference to FIGS. 2 and 3 of some exemplary embodiments of a modular lathe tool adapter, fastener, and tool. Third, with reference to FIG. 4, a valve of a modular lathe tool adapter is described. Fourth, with reference to FIG. 5 and Appendix A, the discussion turns to exemplary embodiments that illustrate the modular lathe tool adapter coupled to a tool changer. Fifth, with reference to APPENDIX C the discussion turns to exemplary embodiments of a coolant nozzle. Sixth, with reference to APPENDIX D and APPENDIX E the discussion turns to exemplary embodiments of devices described herein. Details discussed are not necessarily limited to a particular APPENDIX or a particular embodiment.

FIG. 1 depicts a top perspective view of an illustrative modular lathe tool adapter. In some scenarios, a modular tool adapter connects a milling tool to a lathe turret. Although particular tool examples, and particular turret examples are discussed and otherwise illustrated, embodiments are not limited to those particularities. A given embodiment may include or operate with any type of lathe turret. Also, a given embodiment may include or operate with any type of milling tool holder. Also, a given embodiment may include or operate with any type of nozzle. Also, a given embodiment may include or operate with any type of coolant valve. Also, a given embodiment may include or operate with multiple milling tool holders at once. Also, a given embodiment may include or operate with multiple nozzles at once. Also, a given embodiment may include or operate with multiple valves at once. Also, some embodiments have no coolant attributes.

An adapter 100 may, for example, couple with a lathe turret 105. Advantageously, the adapter 100 may, for example, fluidly couple with the lathe turret 105. The adapter 100 may, for example, include a holder receiver 110. The adapter 100 may, for example, fluidly couple with the holder receiver 110. The holder receiver 110 may, for example, be tapered. The holder receiver 110 may, for example, couple with a tool holder 115. The tool holder 115 may, for example, fluidly connect with the holder receiver 110. The tool holder 115 may, for example, taper at one end. The tool holder 115 may also, for example, be configured to hold cutting tools 120 of varying sizes.

The adapter 100 may, for example, include a switch 125. The switch 125 may, for example, be in fluid communication with the lathe turret 105. The switch 125 may, for example, be in fluid communication with a valve in the adapter 100. The switch 125 may, for example, be rotatably operated, as shown in motion A, to selectively adjust a valve in the adapter 100 between different fluid delivery modes. The switch 125 may, for example, be operated to adjust a valve to a through spindle mode. Operating the switch 125 in through spindle mode may, for example, adjust a valve to enable fluid communication between the holder receiver 110 and the tool holder 115. Operating the switch 125 in through spindle mode may also, for example, adjust a valve to enable fluid communication between the tool holder 115 and the cutting tools 120. The switch 125 may, for example, be operated to adjust a valve to a flood mode. Operating the switch in flood mode may, for example, adjust the valve to enable fluid communication in nozzles 130. The nozzles 130 may, for example, be arranged in a forward-facing position to aim the fluid from the nozzles 130 at a tool.

The switch 125 may, for example, be operated to adjust a valve to a through spindle and flood mode. The switch 125 may, for example, be operated to adjust a valve to an off mode. Operating the switch in off mode may, for example, prevent fluid communication between a valve and the nozzles 130. Operating the switch in off mode may, for example, prevent fluid communication between a valve and the holder receiver 110.

In some embodiments, the adapter 100 may, for example, be configured to include a variety of valves. The valves may, for example, enable the adapter 100 to receive fluid from different entry points. The valves may, for example, include different models. The models may, for example, include different fluid flow.

In some embodiments, the adapter 100 may be, for example, configured for a CAT 40 (Caterpillar) tool holder to be coupled with a BMT (base-mounted turret) lathe turret. The coupling between the CAT 40 tool holder and the BMT lathe turret may, for example, be used to cut metal. The adapter 100 may, for example, couple to the lathe turret in the fashion of a BMT boring tool holder, but instead of coupling via a consistent diameter, it couples via a taper. The adapter 100 may, for example, be configured for a variety of tool holders, turrets, and tool changers. This adapter 100 may, for example, include a valve. A valve may, for example, enable switching between different coolant modes. The coolant modes may, for example, include through spindle mode. The coolant modes may, for example, include variable direction flood mode. The coolant modes may, for example, include through spindle and variable direction flood mode. The coolant modes may, for example, include an off mode.

FIG. 2 depicts a front perspective view of an exemplary modular lathe tool adapter, fastener, and tool holder. The adapter 100 may, for example, be assembled on a lathe turret 105. The adapter 100 may, for example, include a fastener 205. The fastener 205 may, for example, secure and/or stabilize the adapter 100 when the adapter 100 is coupled to the lathe turret 105.

The adapter 100 may, for example, include a brass ball 210. The brass ball 210 may, for example, be retained by a bolt on the front of the adapter 100. The brass ball 210 may, for example, include a copper tube 215. The copper tube 215 may, for example, pivot around the brass ball 210. The pivoting of the copper tube 215 around the brass ball 210 may, for example, advantageously change the direction of the copper tube 215.

In some embodiments, the brass ball 210 may, for example, be integrally formed with the copper tube 215. The brass ball 210 and the copper tube 215 may, for example, pivot inside the adapter 100.

In some embodiments, the nozzles 130 may, for example, be an end portion of the copper tube 215.

In some embodiments, the copper tube 215 may, for example, include the nozzles 130. The copper tube 215 may, for example, be arranged inside the brass ball 210. The brass ball 210 may, for example, be retained by a bolt on the front of the adapter 100.

FIG. 3 depicts a rear perspective view of an exemplary modular lathe tool adapter, fastener, and tool holder depicted in FIG. 2. The adapter 100 may, for example, include a receiver 305. The receiver 305 may, for example, be configured to receive the fastener 205.

FIG. 4 depicts a bottom view of an illustrative modular lathe tool adapter. The adapter 100 may, for example, include a valve 405. The valve 405 may, for example, be in fluid communication with the lathe turret 105. The valve 405 may, for example, be adjustably controlled by the switch 125. The valve 405 may, for example, be in selectable communication with the holder receiver 110. The valve 405 may, for example, be in selectable communication with the nozzles 130.

The adapter 100 may, for example, include at least one lumen 410. The at least one lumen 410 may, for example, enable the valve 405 to fluidly communicate with the switch 125. The at least one lumen 410 may, for example, enable the valve 405 to fluidly communicate with the holder receiver 110. The at least one lumen 410 may, for example, enable the valve 405 to fluidly communicate with the nozzles 130.

FIG. 5 depicts a front perspective view of a modular lathe tool adapter coupled to a tool changer. The adapter 100 may, for example, couple with an automatic tool changer 505. The tool changer 505 may, for example, couple with multiple adapters 100. This may, for example, advantageously enable the tool changer 505 to hold several cutting tools securely at the same time.

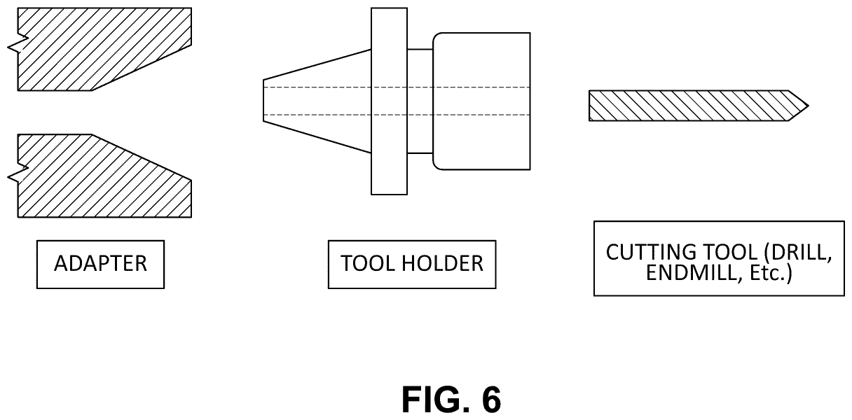

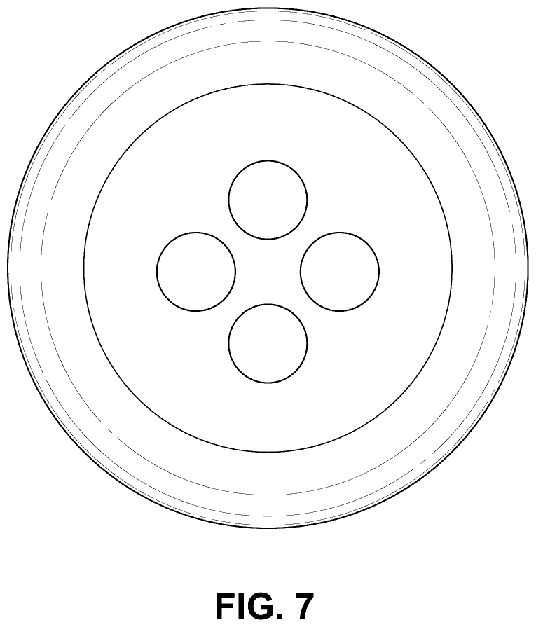

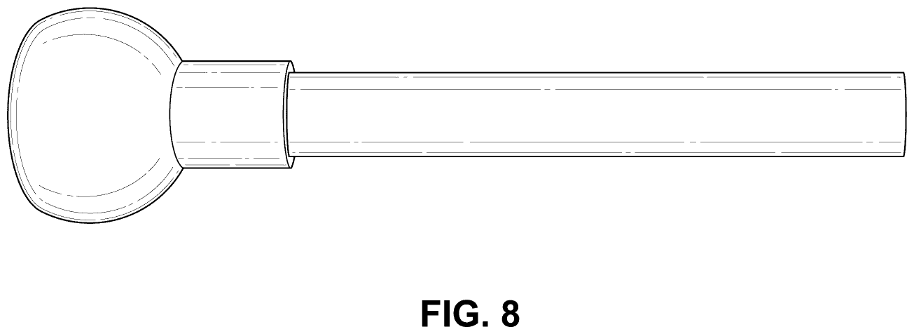

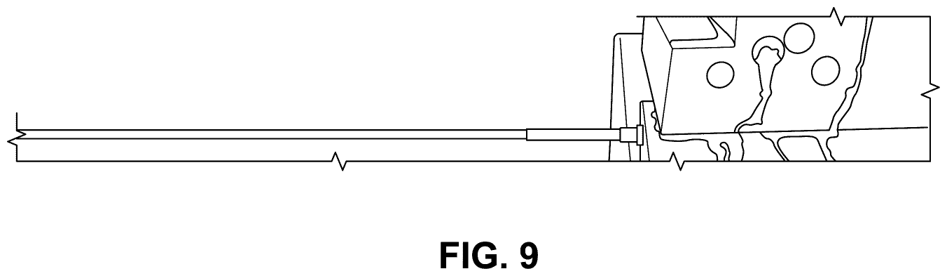

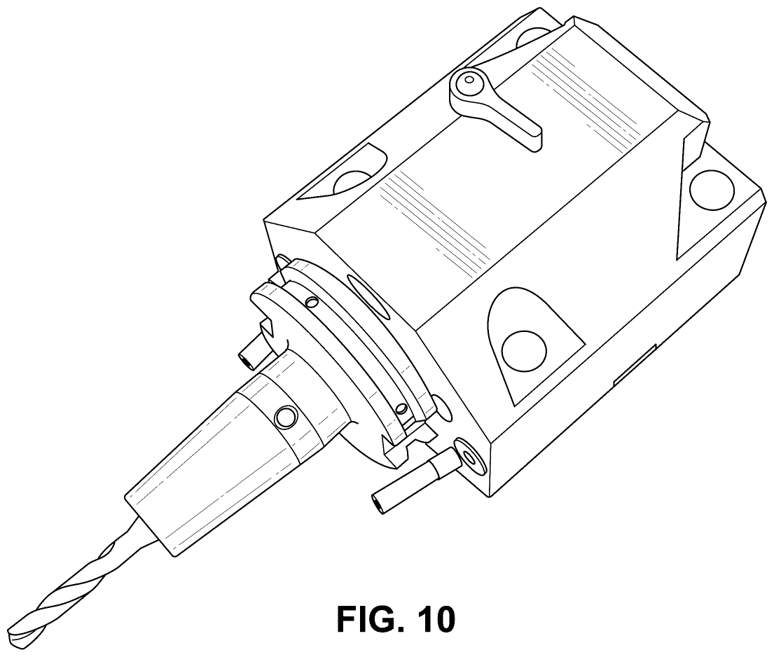

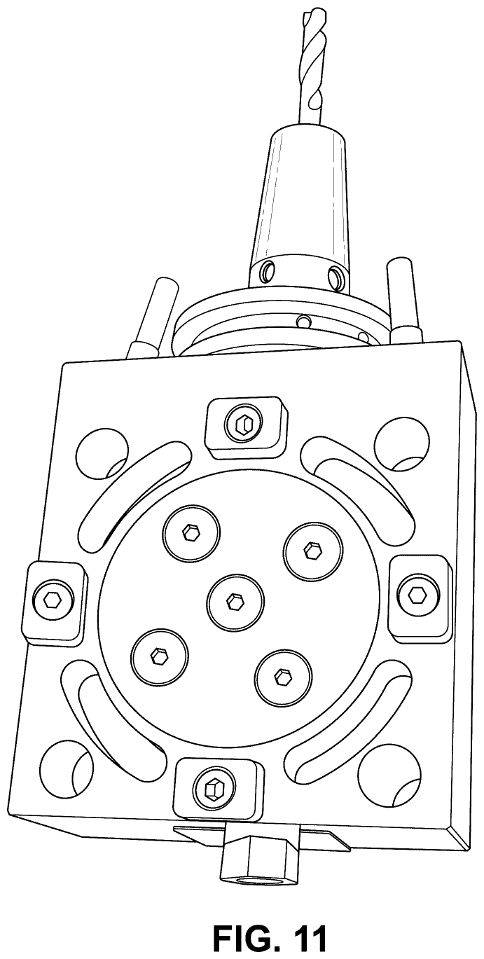

FIG. 6 depicts an exemplary modular lathe tool adapter, tool holder, and cutting tool. The adapter 100 may, for example, couple with a tool holder. The tool holder may, for example, couple with various cutting tools.

In some embodiments, the adapter 100 may, for example, couple with various cutting tools.

APPENDIX A depicts various views of the modular lathe tool adapter coupled to a tool changer, the modular lathe tool adapter, and various connections the modular lathe tool adapter makes with different cutting tools. The adapter 100 may, for example, couple to the tool changer 505. This may, for example, advantageously enable the tool changer 505 to receive different cutting tools. The nozzles 130 may, for example, face in a direction away from the tool changer 505 and towards the cutting tool. The tool changer 505 may, for example, couple with multiple adapters 100. Multiple adapters 100 may, for example, couple with the same and/or different cutting tools.

APPENDIX B depicts various views of the modular lathe tool adapter coupled to a lathe turret, the modular lathe tool adapter itself, and various connections the modular lathe tool adapter makes with different cutting tools.

APPENDIX C depicts various views of a coolant nozzle. In some examples, a laminar flow coolant nozzle may be configured to produce a stream of coolant that is configured to cool a cutting tool in a CNC (computer numerical control) machining application. The laminar flow coolant valve may, for example, be configured to supply a large amount of coolant onto the cutting tool. This may, for example, advantageously enable cooling, chip evacuation, and tool life.

In some embodiments, the nozzle may have four holes on one end. The holes may, for example, be a specific diameter and specific length relative to the output nozzle. The holes extend into the nozzle into a chamber located within the nozzle where the fluid collects. In some implementations, the fluid then finally shoots out of the other side of the nozzle in a laminar stream of coolant.

In some embodiments, the four holes columnize the fluid to ensure that the fluid is flowing in the same direction and at the same speed. Then, by the time the fluid reaches the chamber, the fluid may, for example, be shot out from the nozzle via laminar flow.

In some examples, the coolant nozzle may create a laminar flow, producing a straight, concentrated jet stream of coolant that can be aimed precisely at the cutting tool. Fluid may, for example, enter through multiple small holes, be columnized into a single stream, and exits as a focused jet, improving cooling accuracy and tool life.

FIG. 5 of APPENDIX C depicts the coolant nozzle in use. As shown in FIG. 5 of APPENDIX C, the coolant nozzles create a laminar flow.

Some embodiments include or utilize a laminar flow coolant nozzle. Some laminar flow coolant nozzles produce a tight stream of coolant that is projected out to cool a cutting tool, e.g., in a CNC machining application. A problem with some nozzles is that when they spray coolant, the coolant comes out in a big wide fan, as a cone of coolant so that only a small percentage of coolant actually hits the cutting tool. Such nozzles are not optimal for cooling, and as a result tools wear out faster.

By contrast, some embodiments produce a jet stream of coolant spraying directly onto the tool, which results in better cooling, better chip evacuation, and prolonged tool life. Some embodiments have multiple holes, e.g., two, three, four, five, or six holes, located on the back. In some, the holes are a specific diameter and specific length relative to the output nozzle. The holes connect to a chamber on the inside of the nozzle where fluid collects and is then shot out the end of a nozzle side into a stream of coolant.

By contrast, some nozzles only have a straight hole through the nozzle. Some nozzles do not provide a collimating effect for the fluid. As a result, the fluid is turbulent and bounces around and through the nozzle, so when the fluid comes outside it is in a wide fan instead of a jet stream.

In some embodiments, the four holes (for instance) are collimating the fluid, shaping the flow so it is straight and even, with jets flowing in the same direction and at the same speed. The fluid enters the middle chamber, collects, and is shot out the nozzle in a jet stream instead of a fan.

APPENDIX D depicts various views of a coolant valve. In some examples, a coolant valve may be affixed to a tooling block. The coolant valve may, for example, be coupled to different tool holders. The coolant valve may, in some examples, controllably allow the coolant to shoot out of different exits in a tooling block. The coolant valve may, in some implementations, only allow coolant to shoot out of a front nozzle. This may, for example, be considered flood coolant. The coolant valve may, in some embodiments, enable the coolant to be shot through the center of tooling block onto the tool directly. This may, for example, be considered spindle coolant. In some implementations, the coolant valve may enable the coolant to be shot through both the front nozzle and the tool directly. The coolant valve may, for example, be turned off, which cuts off coolant from exiting the tooling block. In some implementations, the coolant may be sucked up from kidney shaped holes in the bottom of the tooling block.

In some examples, the coolant valve allows the user to select between different coolant modes (flood, through spindle, both, or off) by rotating a lever switch or a button switch, which blocks or opens specific coolant channels inside the block. This enables quick switching between coolant delivery options for different machining tools or operations without changing the hardware setup.

Some embodiments of a coolant valve are suitable for use on a tooling block. Some are suitable for use on various tool holders. In some scenarios, it is beneficial for a coolant to shoot out of one or more nozzles in the front of a tool or out of the center of the tool. Some tools have holes in the front. In some embodiments, a valve system allows the coolant to be shot out of the front, as a flood coolant through spindle coolant which is through the center of the tool in a via which runs through a spindle. In an off position, the valve cuts off the coolant to the whole block. A quick-change valve allows one to quickly change those options with ease instead of having to plumb in extra lines from outside the block or put in screws to block off cooler paths. Some embodiments suck in the coolant through kidney-shaped holes and the coolant makes its way into the block. The valve cuts off or allows certain ports to spray, and flows can be changed easily.

Some embodiments include a block/tool holder/device that accepts different style tool holders (mill tool holders, etc . . . ) that connects to a lathe turret. Some embodiments do not necessarily have coolant capabilities.

APPENDIX E depicts various views of lathe adapters and milling tool holders. Any shape, protrusion, recess, engagement mechanism, channel, opening, projection, or other physical feature shown in any of the APPENDIXES is subject to combination with any other feature described or otherwise illustrated herein to form part of a given embodiment. Likewise, any features called out as part of an embodiment is subject to exclusion from another embodiment. I particular, some embodiments include a valve as a coolant feature, while others have no coolant valve. Also, some embodiments include a nozzle as a coolant feature, while others have no coolant nozzle.

An example one modular lathe tool adapter includes: a valve; and a switch in fluid communication with the valve, the switch rotatably operable to select between different fluid delivery modes, the fluid delivery modes including an off mode.

An example two includes the example one adapter, wherein the fluid delivery modes include a through spindle mode.

An example three includes the example one adapter, wherein the fluid delivery modes include a flood mode.

An example four includes the example one adapter, wherein the switch is configurable for fluid communication with a BMT (base-mounted turret) lathe turret.

An example five includes the example one adapter, wherein the modular lathe tool adapter is configurable for a CAT 40 (Caterpillar) tool holder.

An example six includes the example one adapter, wherein the modular lathe tool adapter includes a tapered holder receiver.

An example seven includes the example one adapter, wherein the modular lathe tool adapter includes a brass ball and a tube, wherein pivoting the tube around the brass ball changes a direction of the tube.

An example eight modular lathe tool adapter includes: a valve; a switch in fluid communication with the valve, the switch operable to select between different fluid delivery modes, the fluid delivery modes including an off mode; and a nozzle in fluid communication with the valve, the nozzle configured to aim fluid at a tool.

An example nine includes the example eight adapter, wherein the modular lathe tool adapter includes multiple nozzles, each nozzle being in fluid communication with the valve.

An example ten includes the example eight adapter, wherein the modular lathe tool adapter includes a copper tube, and the copper tube includes the nozzle.

An example eleven includes the example eight adapter, wherein the nozzle is configured to produce a laminar stream of fluid.

An example twelve includes the example eight adapter, including multiple nozzles, wherein the nozzles are configurable to produce respective jets of fluid, each jet having a respective longitudinal direction vector spanning one inch from where the jets exit the nozzles, and an angle between the direction vectors being less than twenty degrees. In a variation, an angle between the direction vectors is less than ten degrees.

An example thirteen includes the example eight adapter, configured to accept and engage different style tool holders. In a variation, the example one adapter is configured to accept and engage different style tool holders. In another variation, an example fifteen adapter is configured to accept and engage different style tool holders. In another variation, another example adapter according to any description herein is configured to accept and engage different style tool holders.

An example fourteen includes the example eight adapter, including multiple nozzles, wherein the nozzles are configurable to produce respective jets of fluid, each jet having a respective velocity, and a difference between the velocities being less than ten percent of the highest velocity within one inch of where the jets exit the nozzles. In some variations, the difference between the velocities is measured at a different distance from where the jets exit the nozzles, e.g., at one-half inch, or at two inches. In some variations, the difference between the velocities is less than fifteen percent of the highest velocity, or less than five percent of the highest velocity, respectively.

An example fifteen modular lathe tool adapter includes: a valve, the valve affixed to a tooling block, the tooling block having multiple exits, the valve operable to allow a fluid to shoot out of zero or more of the exits; and a switch in fluid communication with the valve, the switch operable to select between different fluid delivery modes, the fluid delivery modes including an off mode.

An example sixteen includes the example fifteen adapter, including a front nozzle configured to direct fluid at a tool, wherein the valve is configurable to allow a fluid to shoot out of the front nozzle only.

An example seventeen includes the example fifteen adapter, configured to enable a fluid to travel through a center of the tooling block directly onto a tool.

An example eighteen includes the example fifteen adapter, configurable to emit a spindle coolant fluid onto a tool.

An example nineteen includes the example fifteen adapter, configurable to emit a spindle coolant fluid onto a tool and to also emit coolant fluid from a front nozzle which is tool-facing.

An example twenty includes the example fifteen adapter, to suck up a coolant fluid up from a kidney-shaped hole in the tooling block. In some variations, the hole is not kidney-shaped; in some, the hole is round, in some the hole is ovoid, and in some the hole is polygonal.

Although various embodiments have been described with reference to the figures, other embodiments are possible.

Although an exemplary system has been described with reference to FIGS. 1-6, APPENDIX A, APPENDIX B, APPENDIX C, APPENDIX D, and APPENDIX E, other implementations may be deployed in other industrial, scientific, medical, commercial, and/or residential applications.

In some embodiments, the holder receiver 110 may, for example, have a uniform diameter.

In other embodiments, the adapter 100 may, for example, include apertures 135. The apertures 135 may, for example, receive fasteners. For example, the apertures 135 receiving fasteners may advantageously couple the adapter 100 to the lathe turret 105. The apertures 135 receiving fasteners may also, for example, advantageously couple at least one adapter to the tool changer 505.

A number of implementations have been described. Nevertheless, it will be understood that various modifications may be made. For example, advantageous results may be achieved if components of the disclosed adapter 100 were combined in a different manner.

For the purposes of United States law and practice, use of the word “step” herein, in the claims or elsewhere, is not intended to invoke means-plus-function, step-plus-function, or 35 United State Code Section 112 Sixth Paragraph/Section 112(f) claim interpretation. Any presumption to that effect is hereby explicitly rebutted.

For the purposes of United States law and practice, the claims are not intended to invoke means-plus-function interpretation unless they use the phrase “means for”. Claim language intended to be interpreted as means-plus-function language, if any, will expressly recite that intention by using the phrase “means for”. When means-plus-function interpretation applies, whether by use of “means for” and/or by a court's legal construction of claim language, the means recited in the specification for a given noun or a given verb should be understood to be linked to the claim language and linked together herein by virtue of any of the following: appearance within the same block in a block diagram of the figures, denotation by the same or a similar name, denotation by the same reference numeral, a functional relationship depicted in any of the figures, a functional relationship noted in the present disclosure's text. For example, if a claim limitation recited a “zac widget” and that claim limitation became subject to means-plus-function interpretation, then at a minimum all structures identified anywhere in the specification in any figure block, paragraph, or example mentioning “zac widget”, or tied together by any reference numeral assigned to a zac widget, or disclosed as having a functional relationship with the structure or operation of a zac widget, would be deemed part of the structures identified in the application for zac widgets and would help define the set of equivalents for zac widget structures.

Throughout this document, unless expressly stated otherwise any reference to a step in a process presumes that the step may be performed directly by a party of interest and/or performed indirectly by the party through intervening mechanisms and/or intervening entities, and still lie within the scope of the step. That is, direct performance of the step by the party of interest is not required unless direct performance is an expressly stated requirement.

To the extent any human activity is arguably within the scope of any claim based on the present disclosure, that human activity scope is hereby expressly disclaimed and expressly disavowed. Human-machine interaction may be properly noted in a claim for context. But only the portion of the effective claim scope which is eligible and supported herein by the description of non-human mechanisms, as understood by one of skill in the art, is retained.

An “embodiment” herein is an example. The term “embodiment” is not interchangeable with “the invention”. Embodiments may freely share or borrow aspects to create other embodiments (provided the result is operable), even if a resulting combination of aspects is not explicitly described per se herein. Requiring each and every permitted combination to be explicitly and individually described is unnecessary for one of skill in the art, and would be contrary to policies which recognize that patent specifications are written for readers who are skilled in the art. Formal combinatorial calculations and informal common intuition regarding the number of possible combinations arising from even a small number of combinable features will also indicate that a large number of aspect combinations exist for the aspects described herein. Accordingly, requiring an explicit recitation of each and every combination would be contrary to policies calling for patent specifications to be concise and for readers to be knowledgeable in the technical fields concerned.

Reference numerals are provided for convenience and in support of the drawing figures and as part of the text of the specification, which collectively describe aspects of embodiments by reference to multiple items. Items which do not have a unique reference numeral may nonetheless be part of a given embodiment. For better legibility of the text, a given reference numeral is recited near some, but not all, recitations of the referenced item in the text. The same reference numeral may be used with reference to different examples or different instances of a given item.

Although particular embodiments are expressly illustrated and described herein as processes or as apparatus or as systems, it will be appreciated that discussion of one type of embodiment also generally extends to other embodiment types. For instance, the descriptions of processes in connection with the Figures also help describe the technical effects and operation of systems and manufactures like those discussed in connection with other Figures. It does not follow that any limitations from one embodiment are necessarily read into another.

With due attention to the items provided herein, including technical processes, technical effects, technical mechanisms, and technical details which are illustrative but not comprehensive of all claimed or claimable embodiments, one of skill will understand that the present disclosure and the embodiments described herein are not directed to subject matter outside the technical arts, or to any idea of itself such as a principal or original cause or motive, or to a mere result per se, or to a mental process or mental steps, or to a business method or prevalent economic practice, or to a mere method of organizing human activities, or to a law of nature per se, or to a naturally occurring thing or process, or to a living thing or part of a living thing, or to a mathematical formula per se, or to isolated software per se, or to a merely conventional computer, or to anything wholly imperceptible or any abstract idea per se, or to insignificant post-solution activities, or to any method implemented entirely on an unspecified apparatus, or to any method that fails to produce results that are useful and concrete, or to any preemption of all fields of usage, or to any other subject matter which is ineligible for patent protection under the laws of the jurisdiction in which such protection is sought or is being licensed or enforced.

Reference herein to an embodiment having some feature X and reference elsewhere herein to an embodiment having some feature Y does not exclude from this disclosure embodiments which have both feature X and feature Y, unless such exclusion is expressly stated herein. All possible negative claim limitations are within the scope of this disclosure, in the sense that any feature which is stated to be part of an embodiment may also be expressly removed from inclusion in another embodiment, even if that specific exclusion is not given in any example herein. The term “embodiment” is merely used herein as a more convenient form of “process, system, article of manufacture, and/or other example of the teachings herein as applied in a manner consistent with applicable law.” Accordingly, a given “embodiment” may include any combination of features disclosed herein, provided the embodiment is consistent with at least one claim.

Not every item shown in the Figures need be present in every embodiment. Conversely, an embodiment may contain item(s) not shown expressly in the Figures. Although some possibilities are illustrated here in text and drawings by specific examples, embodiments may depart from these examples. For instance, specific technical effects or technical features of an example may be omitted, renamed, grouped differently, repeated, instantiated differently, or be a mix of effects or features appearing in two or more of the examples. Functionality shown at one location may also be provided at a different location in some embodiments; one of skill recognizes that functionality modules can be defined in various ways in a given implementation without necessarily omitting desired technical effects from the collection of interacting modules viewed as a whole. Distinct steps may be shown together in a single box in the Figures, due to space limitations or for convenience, but nonetheless be separately performable, e.g., one may be performed without the other in a given performance of a method.

Reference has been made to the figures throughout by reference numerals. Any apparent inconsistencies in the phrasing associated with a given reference numeral, in the figures or in the text, should be understood as simply broadening the scope of what is referenced by that numeral. Different instances of a given reference numeral may refer to different embodiments, even though the same reference numeral is used. Similarly, a given reference numeral may be used to refer to a verb, a noun, and/or to corresponding instances of each, e.g., an adaptor adapts, a switch switches, etc.

As used herein, terms such as “a”, “an”, and “the” are inclusive of one or more of the indicated item or step. In particular, in the claims a reference to an item generally means at least one such item is present and a reference to a step means at least one instance of the step is performed. Similarly, “is” and other singular verb forms should be understood to encompass the possibility of “are” and other plural forms, when context permits, to avoid grammatical errors or misunderstandings.

Headings are for convenience only; information on a given topic may be found outside the section whose heading indicates that topic.

All claims and the abstract, as filed, are part of the specification. The abstract is provided for convenience and for compliance with patent office requirements; it is not a substitute for the claims and does not govern claim interpretation in the event of any apparent conflict with other parts of the specification. Similarly, any summary is provided for convenience and does not govern in the event of any conflict with the claims or with other parts of the specification. Claim interpretation shall be made in view of the specification as understood by one of skill in the art; it is not required to recite every nuance within the claims themselves as though no other disclosure was provided herein.

To the extent any term used herein implicates or otherwise refers to an industry standard, and to the extent that applicable law requires identification of a particular version of such a standard, this disclosure shall be understood to refer to the most recent version of that standard which has been published in at least draft form (final form takes precedence if more recent) as of the earliest priority date of the present disclosure under applicable patent law.

While exemplary embodiments have been shown in the drawings and described above, it will be apparent to those of ordinary skill in the art that numerous modifications can be made without departing from the principles and concepts set forth in the claims, and that such modifications need not encompass an entire abstract concept. Although the subject matter is described in language specific to structural features and/or procedural acts, it is to be understood that the subject matter defined in the appended claims is not necessarily limited to the specific technical features or acts described above the claims. It is not necessary for every means or aspect or technical effect identified in a given definition or example to be present or to be utilized in every embodiment. Rather, the specific features and acts and effects described are disclosed as examples for consideration when implementing the claims.

All changes which fall short of enveloping an entire abstract idea but come within the meaning and range of equivalency of the claims are to be embraced within their scope to the full extent permitted by law.

What is claimed is:

1. A modular lathe tool adapter, comprising:
a valve; and
a switch in fluid communication with the valve, the switch rotatably operable to select between different fluid delivery modes, the fluid delivery modes comprising an off mode.

2. The modular lathe tool adapter of claim 1, wherein the fluid delivery modes comprise a through spindle mode.

3. The modular lathe tool adapter of claim 1, wherein the fluid delivery modes comprise a flood mode.

4. The modular lathe tool adapter of claim 1, wherein the switch is configurable for fluid communication with a BMT (base-mounted turret) lathe turret.

5. The modular lathe tool adapter of claim 1, wherein the modular lathe tool adapter is configurable for a CAT 40 (Caterpillar) tool holder.

6. The modular lathe tool adapter of claim 1, wherein the modular lathe tool adapter comprises a tapered holder receiver.

7. The modular lathe tool adapter of claim 1, wherein the modular lathe tool adapter comprises a brass ball and a tube, wherein pivoting the tube around the brass ball changes a direction of the tube.

8. A modular lathe tool adapter, comprising:
a valve;
a switch in fluid communication with the valve, the switch operable to select between different fluid delivery modes, the fluid delivery modes comprising an off mode; and
a nozzle in fluid communication with the valve, the nozzle configured to aim fluid at a tool.

9. The modular lathe tool adapter of claim 8, wherein the modular lathe tool adapter comprises multiple nozzles, each nozzle being in fluid communication with the valve.

10. The modular lathe tool adapter of claim 8, wherein the modular lathe tool adapter comprises a copper tube, and the copper tube comprises the nozzle.

11. The modular lathe tool adapter of claim 8, wherein the nozzle is configured to produce a laminar stream of fluid.

12. The modular lathe tool adapter of claim 8, comprising multiple nozzles, wherein the nozzles are configurable to produce respective jets of fluid, each jet having a respective longitudinal direction vector spanning one inch from where the jets exit the nozzles, and an angle between the direction vectors being less than twenty degrees.

13. The modular lathe tool adapter of claim 8, configured to accept and engage different style tool holders.

14. The modular lathe tool adapter of claim 8, comprising multiple nozzles, wherein the nozzles are configurable to produce respective jets of fluid, each jet having a respective velocity, and a difference between the velocities being less than ten percent of the highest velocity within one inch of where the jets exit the nozzles.

15. A modular lathe tool adapter, comprising:
a valve, the valve affixed to a tooling block, the tooling block having multiple exits, the valve operable to allow a fluid to shoot out of zero or more of the exits; and
a switch in fluid communication with the valve, the switch operable to select between different fluid delivery modes, the fluid delivery modes comprising an off mode.

16. The modular lathe tool adapter of claim 15, comprising a front nozzle configured to direct fluid at a tool, wherein the valve is configurable to allow a fluid to shoot out of the front nozzle only.

17. The modular lathe tool adapter of claim 15, configured to enable a fluid to travel through a center of the tooling block directly onto a tool.

18. The modular lathe tool adapter of claim 15, configurable to emit a spindle coolant fluid onto a tool.

19. The modular lathe tool adapter of claim 15, configurable to emit a spindle coolant fluid onto a tool and to also emit coolant fluid from a front nozzle which is tool-facing.

20. The modular lathe tool adapter of claim 15, configured to suck up a coolant fluid up from a kidney-shaped hole in the tooling block.
